(19) United States
(12) Patent Application Publication
(10) Pub. No.: US 2014/0071945 A1
(43) Pub. Date: Mar. 13, 2014

(54) Device Triggering Method and Network Element Device

(71) Applicant: Huawei Device Co., Ltd., Shenzhen (CN)

(72) Inventor: Xiaojuan Li, Beijing (CN)

(73) Assignee: Huawei Device Co., Ltd., Shenzhen (CN)

(21) Appl. No.: 14/077,415

(22) Filed: Nov. 12, 2013

Related U.S. Application Data
(63) Continuation of application No. PCT/CN2012/075334, filed on May 11, 2012.

(30) Foreign Application Priority Data
May 13, 2011 (CN) 201110123607.5

(51) Int. Cl. H04W 4/00

(52) U.S. Cl. CPC H04W 4/003
USPC 370/331; 455/419

(57) ABSTRACT

Embodiments of the present invention disclose a device triggering method and device. A device triggering method includes: receiving, by a mobility management network element, a device application trigger request; and sending a request carrying the device application trigger request to an access network element to make the access network element trigger a device; or, sending a request carrying the device application trigger request to a gateway network element to make the gateway network element trigger a device. A solution according to the embodiments of the present invention improves initiative and real-timeness in triggering an M2M device or an H2H device.

### CROSS-REFERENCE TO RELATED APPLICATIONS

This application is a continuation of international Application No. PCT/CN2012/075334, filed on May 11, 2012, which claims priority to Chinese Patent Application No. 201110123607.5, filed on May 13, 2011, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of communications technologies, and in particular, to a device triggering method and a network element device.

### BACKGROUND

Existing means of communication mainly include two communication models: human to human (H2H) and machine to machine (M2M).

An H2H application mainly refers to communications in which humans are communication objects, such as telephone communications; but an M2M application is also called a machine type communications (MTC) application and refers to network communications between multiple network elements without involvement of humans, for example, traffic control and management, remote meter reading, remote monitoring, mobile payment, positioning and tracking, medical monitoring, and another application. M2M technologies combine communications and network technologies and may connect machines and devices spread all over people's daily lives to form a network, so that the devices become more “intelligent”, and therefore rich applications may be created, thereby incurring a new round of changes to ways of daily life, industrial production, and the like. In various future M2M applications, in order to better enable a network side to manage a device, the industry proposes a feature of M2M device triggering: when an M2M application server requires an M2M device to communicate with the M2M application server, the M2M device is required to be triggered first before the M2M device performs data exchange with the M2M application server through a network.

In an existing triggering mechanism of an M2M device or of an H2H device, a device first actively sends non-access stratum (NAS) signaling such as an attach request or a tracking area update request, and after receiving the NAS signaling sent by the device, a core network makes a device application trigger request be carried in a response corresponding to the NAS signaling and sent to the device to complete triggering of the device.

### SUMMARY

Embodiments of the present invention provide a device triggering method and a network element device, so as to improve initiative and real-timeness in triggering an M2M device or an H2H device.

In order to solve the technical problem, an embodiment of the present invention provides the following technical solution:

A device triggering method includes: receiving, by a mobility management network element, a device application trigger request; and sending a request carrying the device application trigger request to an access network element to make the access network element trigger a device; or, sending a request carrying the device application trigger request to a gateway network element to make the gateway network element trigger a device.

A device triggering method includes: receiving, by a gateway network element, a request that is from a mobility management network element and carries a device application trigger request; and sending a data packet carrying the device application trigger request to a device to trigger the device.

A mobility management network element includes: a receiving module configured to receive a device application trigger request; a first sending module configured to send a request carrying the device application trigger request to an access network element to make the access network element trigger a device; or, a second sending module configured to send a request carrying the device application trigger request to a gateway network element to make the gateway network element trigger a device.

A gateway network element includes: a second receiving module configured to receive a request that is from a mobility management network element and carries a device application trigger request; and a fourth sending module configured to send a data packet carrying the device application trigger request to a device to trigger the device.

It can be seen from the above that, in the embodiment of the present invention, after receiving a device application trigger request, a mobility management network element delivers the device application trigger request to an access network element or a gateway network element through an actively originated request, so as to enable the access network element or the gateway network element to deliver the device application trigger request to a corresponding device to trigger the device. The mechanism relatively improves initiative and real-timeness of a network in delivering the device application trigger request, thereby triggering an M2M device or an H2H device in a more timely and efficient manner to exchange data with an application server.

### BRIEF DESCRIPTION OF THE DRAWINGS

To illustrate the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic flow chart of a device triggering method according to an embodiment of the present invention;

FIG. 2 is a schematic flow chart of another device triggering method according to an embodiment of the present invention;

FIG. 3 is a schematic flow chart of still another device triggering method according to an embodiment of the present invention;

FIG. 4 is a schematic flow chart of still another device triggering method according to an embodiment of the present invention;

FIG. 5 is a schematic flow chart of still another device triggering method according to an embodiment of the present invention;

FIG. 6 is a schematic flow chart of still another device triggering method according to an embodiment of the present invention;

FIG. 7A is a schematic structural diagram of a mobility management network element according to an embodiment of the present invention;

FIG. 7B is a schematic structural diagram of another mobility management network element according to an embodiment of the present invention;

FIG. 7C is a schematic structural diagram of still another mobility management network element according to an embodiment of the present invention;

FIG. 8 is a schematic structural diagram of a gateway network element according to an embodiment of the present invention; and

FIG. 9 is a schematic diagram of a communication system according to an embodiment of the present invention.

### DETAILED DESCRIPTION

Embodiments of the present invention provide a device triggering method and a network element device, so as to improve initiative and real-timeness in triggering an M2M device or an H2H device.

To make the invention objectives, features, and advantages of the present invention more apparent and comprehensible, the following clearly describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

It should be noted first that an access network element according to embodiments of the present invention refers to an entity capable of implementing a user equipment radio access management function, a mobility management network element according to embodiments of the present invention refers to an entity capable of implementing a user equipment mobility management logical function, and the access network element and the mobility management network element may have different names, locations, and product forms in different networks.

For example, an access network element mentioned in the following embodiments of the present invention may refer to, for example: an evolved NodeB (eNodeB), a home eNodeB (HeNB), or a base station of another type in an evolved Universal Mobile Telecommunications System (UMTS) territorial radio access network (E-UTRAN); or, a base station controller or a radio network controller (RNC) in a UMTS territorial radio access network (UTRAN)/Global System for Mobile Communications (GSM) Enhanced Data Rates for GSM Evolution (EDGE) radio access network (GERAN); or may refer to an entity having a high rate packet data access network (HRPD-AN) logical function in a wideband Code Division Multiple Access (CDMA) network and an entity having an evolved packet data gateway (EPDG) access network logical function in a wireless local area network (WLAN); or an access service network base station (ASN-BS) in a Worldwide Interoperability for Microwave Access (WiMAX) network or an entity implementing terminal radio access management in another network.

For example, a mobility management network element mentioned in embodiments of the present invention may refer to a mobility management entity (MME) connected to an E-UTRAN and a serving general packet radio service support node (SGSN) connected to a UTRAN/GERAN; or an access gateway (AGW) in a non-3^{rd} Generation Partnership Project (3GPP) network, an entity ePDG having a mobility management logical function in a WLAN, an access service network gateway (ASN GW) in a worldwide interoperability for microwave access WiMAX network, or an entity having an HRPD-AN mobility management logical function in a CDMA network, or an entity implementing a user equipment mobility management logical function in another network.

A home location server mentioned in embodiments of the present invention refers to Home Location Register (HLR), Home Subscriber Server (HSS), or the like.

A device mentioned in embodiments of the present invention refers to an H2H device or an M2M device, and the solution of the embodiments of the present invention is used to trigger an H2H device or an M2M device.

Detailed illustration is provided below through specific embodiments.

An embodiment of a device triggering method of the present invention may include: receiving, by a mobility management network element, a device application trigger request from a home location server; sending a request (for example, a control plane request) carrying the device application trigger request to a device (for example, an H2H device or an M2M device), so as to trigger the device; or, sending a request (for example, a control plane request) carrying the device application trigger request to an access network element, so that the access network element triggers the device; or, sending a request (for example, a control plane request) message carrying the device application trigger request to a gateway network element, so that the gateway network element triggers the device.

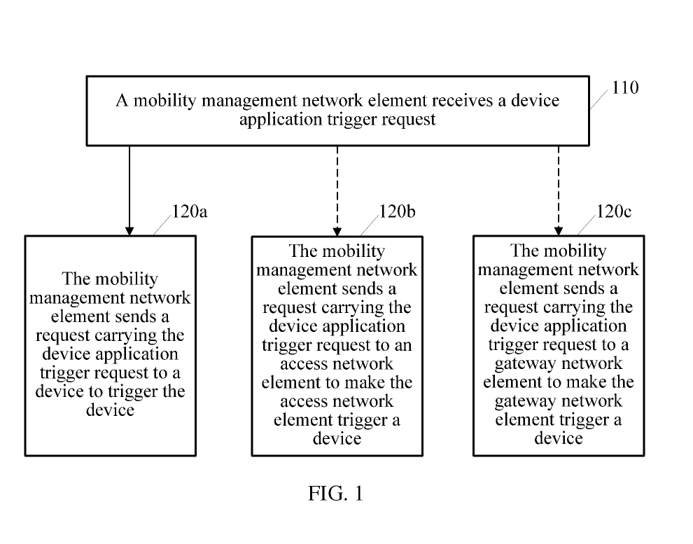

Referring to FIG. 1, specific steps may include:

110. A mobility management network element receives a device application trigger request.

In an application scenario, if an application server needs to trigger a certain M2M device or a certain H2H device to communicate with the application server (for example, the Application Server needs a certain M2M device to report a certain type of data to the application server), the Application Server may send a device application trigger request (user equipment (UE) application trigger request) to a home location server, and the UE application trigger request carries a device identifier of the M2M device or the H2H device that needs to be triggered.

In addition, the Application Server may send a high priority processing instruction (the high priority processing instruction may be included in the UE application trigger request or may be not included in the UE application trigger request) to the home location server at the same time when sending the UE application trigger request to the home location server, so as to instruct a device, which receives the UE application trigger request, to process the UE application trigger request in a timely manner.

After receiving the UE application trigger request sent by the Application Server, the home location server may store the UE application trigger request, and make the UE application trigger request be carried in an Insert Subscriber Data Request, a Cancel Location request, or another request or message and sent to the mobility management network element. In addition, the home location server may further make the message, which is sent to the mobility management network element and carries the UE application trigger request, carry a high priority processing instruction (if the UE application trigger request sent by the Application Server to the home location server includes a high priority processing instruction, the home location server may make the UE application trigger request that includes the high priority processing instruction be carried in a certain message and sent to the mobility management network element; and if the UE application trigger request sent by the Application Server to the home location server does not include a high priority processing instruction, the home location server may insert a high priority processing instruction into the message that is sent to the mobility management network element and carries the UE application trigger request), so as to instruct the device, which receives the UE application trigger request, to process the UE application trigger request in a timely manner.

Execute step 120a, 120b, or 120c.

120a. The mobility management network element sends a request (for example, a control plane request) carrying the device application trigger request to a device to trigger the device.

It should be noted that the control plane request refers to a control plane request (that is, a request originated by a control plane) actively initiated by a local end (the local end herein refers to the mobility management network element), but is not a response to a request from another device.

The mobility management network element, for example, may send a Paging request or a Detach request, which carries the device application trigger request, to a device (for example, an H2H device or an M2M device) to trigger the device (herein, the function of sending, by the mobility management network element, the Detach request is not to instruct the device to detach, and therefore, after receiving the Detach request, the device may obtain the UE application trigger request from the Detach request, but does not execute detaching), or the mobility management network element may send another control plane request carrying the UE application trigger request to an M2M device or an H2H device to trigger the device.

For example, the mobility management network element may make the UE application trigger request be carried in a non Critical Extension field or another field of the Paging request, the device may correspondingly obtain the UE application trigger request from the non Critical Extension field or the another field of the Paging request, and the device may perform data exchange with the Application Server accordingly.

It can be seen that after the mobility management network element receives the UE application trigger request, if the mobility management network element delivers the UE application trigger request to the device through the actively originated control plane request, initiative of the mobility management network element in delivering the UE application trigger request is improved, thereby ensuring that the UE application trigger request reaches, for example, an H2H device or an M2M device in real time.

120b. The mobility management network element sends a request carrying the device application trigger request to an access network element to make the access network element trigger a device.

The mobility management network element, for example, may send a radio access bearer setup request, a radio access bearer modification request, a radio access bearer release request, or another control plane request, which carries the UE application trigger request, to the access network element. The access network element may correspondingly obtain the UE application trigger request from the request.

For example, the mobility management network element may make the received UE application trigger request be carried in an evolved packet system-protocol data unit (EPS-PDU) or another field of a radio access bearer setup request, a radio access bearer modification request, or a radio access bearer release request, and after the access network element receives the radio access bearer setup request, the radio access bearer modification request, or the radio access bearer release request, the access network element may obtain the UE application trigger request from the EPS-PDU or the another field of the message.

Further, the mobility management network element, for example, may further make a high priority processing instruction be carried in the request carrying the UE application trigger request, so as to instruct the access network element, which receives the request, to deliver the UE application trigger request to a corresponding device, such as an H2H device or an M2M device, in a timely manner to trigger the device.

Further, the access network element, for example, may send a Radio Connection Reconfiguration (RRC) request (for example, the UE application trigger request may be carried in a critical Extensions Future field or another field of the RRC request) or another message, which carries the UE application trigger request, to the corresponding device, such as the H2H device or the M2M device, and after receiving the RRC request or the another request or message, the device such as the H2H device or the M2M device may obtain the UE application trigger request from the critical Extensions Future field or the another field of the request or message, establish a communication channel with the Application Server accordingly, and perform data exchange.

It can be seen that after the mobility management network element receives the UE application trigger request, if the mobility management network element delivers the UE application trigger request to the access network element through the actively originated control plane request, the access network element is enabled to deliver the UE application trigger request to, for example, the H2H device or the M2M device in a timely manner to trigger the device, initiative of a network in delivering the UE application trigger request is improved, thereby ensuring that the UE application trigger request reaches the H2H device or the M2M device in real time.

120c. The mobility management network element sends a request carrying the device application trigger request to a gateway network element to make the gateway network element trigger a device.

For example, the mobility management network element may send a Modify Bearer Request or a Create Bearer Request, which carries the device application trigger request, to the gateway network element to make the gateway network element trigger the device (herein, the function of sending, by the mobility management network element, the Modify Bearer Request or the Create Bearer Request is not necessarily to instruct the gateway network element to modify a bearer or create a bearer, and therefore, after receiving the Modify Bearer Request or the Create Bearer Request, the gateway network element may obtain the UE application trigger request therefrom, but may not execute a bearer modification or bearer creation operation), or the mobility management network element may send another control plane request carrying the device application trigger request to the gateway network element to make the gateway network element trigger the device. The gateway network element may correspondingly obtain the UE application trigger request from the request.

For example, the mobility management network element may make the UE application trigger request be carried in a Protocol Configuration Option field or another field of the Modify Bearer Request or the Create Bearer Request, and after receiving the Modify Bearer Request or the Create Bearer Request, the gateway network element may obtain the UE application trigger request from the Protocol Configuration Option field or the another field of the request.

Further, the mobility management network element, for example, may further make a high priority processing instruction be carried in the request, which is sent to the gateway network element and carries the device application trigger request, to instruct the gateway network element, which receives the request message, to deliver the UE application trigger request to a corresponding device, such as an H2H device or an M2M device, in a timely manner through a user plane data packet, so as to trigger the device.

In addition, the gateway network element, for example, may send a downlink data packet or another user plane data packet, which carries the UE application trigger request, to a corresponding M2M device, and after receiving the downlink data packet or the another user plane data packet, the device may obtain the UE application trigger request from the data packet, establish a communication channel with the Application Server accordingly, and perform data exchange.

In an actual application, after the receiving the device application trigger request, the method may further include: determining, by the mobility management network element, whether a device corresponding to the device identifier already detaches; if no, sending a request carrying the device application trigger request to the device to trigger the device; or, sending a request carrying the device application trigger request to an access network element to make the access network element trigger the device; or, sending a request carrying the device application trigger request to a gateway network element to make the gateway network element trigger the device; if yes, sending a message indicating a failure in triggering the device to the home location server. Certainly, the mobility management network element may also take it by default that the device does not detach, and therefore send a request carrying the device application trigger request to the device to trigger the device; or, send a request carrying the device application trigger request to an access network element to make the access network element trigger the device; or send a request carrying the device application trigger request to a gateway network element to make the gateway network element trigger the device, but do not execute the step of determining whether the device corresponding to the device identifier already detaches.

It can be seen that after the mobility management network element receives the UE application trigger request, if the mobility management network element delivers the UE application trigger request to a gateway network element through an actively originated control plane request, the gateway network element is enabled to deliver the UE application trigger request to a device, such as an H2H device or an M2M device, in a timely manner through a user plane data packet to trigger the device, initiative of a network in delivering the UE application trigger request is improved, thereby ensuring that the UE application trigger request reaches in real time the device to be triggered.

Description is provided below from the perspective of a gateway network element.

Another embodiment of a device triggering method according to the embodiment of the present invention includes: receiving, by a gateway network element, a request that is from a mobility management network element and carries a device application trigger request; and sending a data packet (for example, a downlink data packet) carrying the device application trigger request to a device.

The mobility management network element, for example, may send a Modify Bearer Request or a Create Bearer Request, which carries the device application trigger request, to the gateway network element to make the gateway network element trigger the device (herein, the function of sending, by the mobility management network element, the Modify Bearer Request or the Create Bearer Request is not necessarily to instruct the gateway network element to modify a bearer or create a bearer, and therefore, after receiving the Modify Bearer Request or the Create Bearer Request, the gateway network element may obtain the UE application trigger request therefrom, but may not execute a bearer modification or bearer creation operation), or the mobility management network element may send another control plane request carrying the device application trigger request to the gateway network element to make the gateway network element trigger the device. The gateway network element may correspondingly obtain the UE application trigger request from the request message.

For example, the mobility management network element may make the UE application trigger request be carried in a Protocol Configuration Option field or another field of the Modify Bearer Request or the Create Bearer Request, and after receiving the Modify Bearer Request or the Create Bearer Request, the gateway network element may obtain the UE application trigger request from the Protocol Configuration Option field or the another field of the request message.

Further, the mobility management network element, for example, may further make a high priority processing instruction be carried in the request, which is sent to the gateway network element and carries the device application trigger request, to instruct the gateway network element, which receives the request message, to deliver the UE application trigger request to a corresponding device, such as an H2H device or an M2M device, in a timely manner through a user plane data packet, so as to trigger the device.

In addition, the gateway network element, for example, may send a downlink data packet or another user plane data packet, which carries the UE application trigger request, to a corresponding device, and after receiving the downlink data packet or the another user plane data packet, the H2H device or the M2M device may obtain the UE application trigger request from the data packet, establish a communication channel with the Application Server accordingly, and perform data exchange.

It can be seen from the above that, in this embodiment, after receiving the device application trigger request, the mobility management network element delivers the device application trigger request to the device through an actively originated request, or delivers the device application trigger request to an access network element or a gateway network element through an actively originated request, so as to enable the access network element or the gateway network element to deliver the device application trigger request to the corresponding device to trigger the device. The mechanism improves initiative and real-timeness of a network in delivering the device application trigger request, thereby triggering a device, such as an M2M device or an H2H device in a more timely and efficient manner, to exchange data with an application server.

To make the technical solutions of the embodiment of the present invention better understood and implemented, the following provides illustration by using an example of an application scenario where an M2M device is triggered in a Long Term Evolution (LTE) system. An application scenario of triggering an H2H device may be derived accordingly.

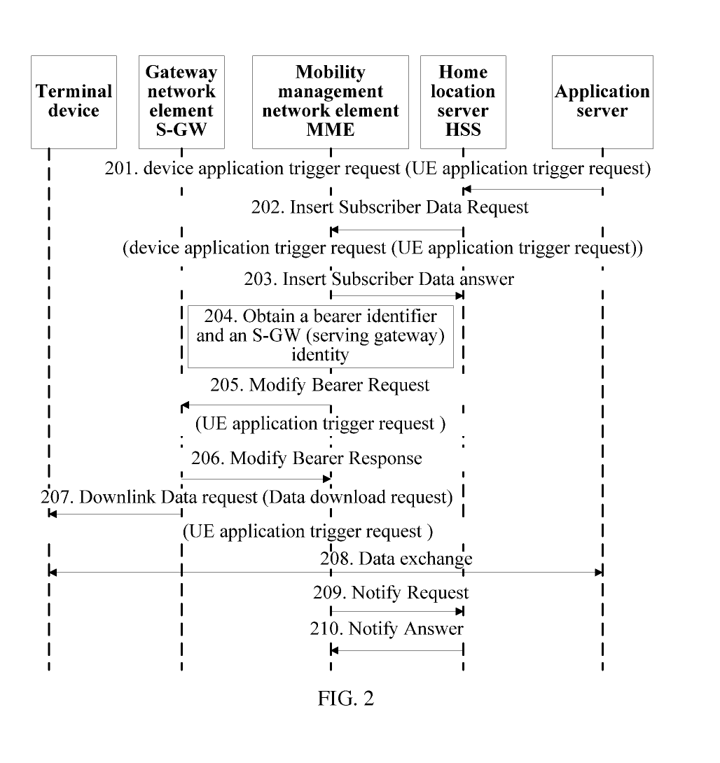

Referring to FIG. 2, specific steps may include:

201. An Application Server sends a UE application trigger request to an HSS.

In an actual application, the Application Server may directly send the UE application trigger request to the HSS, or make the UE application trigger request be carried in a certain request or a certain message and sent to the HSS. The UE application trigger request may carry a device identifier of an M2M device that needs to be triggered.

In addition, the Application Server may send a high priority processing instruction (the high priority processing instruction may be included in the UE application trigger request or may be not included in the UE application trigger request) to the HSS at the same time when sending the UE application trigger request to the HSS, so as to instruct a device, which receives the UE application trigger request, to process the UE application trigger request in a timely manner.

202. The HSS receives and stores the UE application trigger request.

The HSS sends the UE application trigger request to an MME.

In an actual application, the HSS, for example, may make the UE application trigger request be carried in an Insert Subscriber Data Request, a Cancel Location request, or another message and sent to the MME. FIG. 2 shows an example where the HSS makes the UE application trigger request be carried in the Insert Subscriber Data Request and sent to the MME.

In addition, the HSS may further make a high priority processing instruction be carried in the message that is sent to the MME and carries the UE application trigger request, so as to instruct a device, which receives the UE application trigger request, to process the UE application trigger request in a timely manner.

203. The MME receives the UE application trigger request from the HSS.

The MME, for example, may receive the Insert Subscriber Data Request, the Cancel Location request, or another message, where the Insert Subscriber Data Request, the Cancel Location request, or the another message is from the HSS and carries the UE application trigger request, and obtain the UE application trigger request therein from the HSS.

The MME may send an Insert Subscriber Data answer, a Cancel Location Acknowledge (ACK) response, or another corresponding response to the HSS, and FIG. 2 shows an example where the MME sends the Insert Subscriber Data answer to the HSS.

204. The MME obtains a default bearer identity or a dedicated bearer identity, where the default bearer identity or the dedicated bearer identity is corresponding to an M2M device, and a gateway network element (e.g., a serving gateway (S-GW)) identity, so as to subsequently send the UE application trigger request to an S-GW through a Modify Bearer Request or a Create Bearer Request, so that the S-GW may send the UE application trigger request to the M2M device through a user plane bearer.

205. The MME sends a Modify Bearer Request or a Create Bearer Request to the S-GW.

The Modify Bearer Request or the Create Bearer Request sent by the MME to the S-GW, carries the UE application trigger request, and further carries the default bearer identity or the dedicated bearer identity.

In an actual application, the UE application trigger request, for example, may be carried in a Protocol Configuration Option field in the Create Bearer Request or the Modify Bearer Request, and certainly may be carried in another field.

FIG. 2 shows an example where the MME sends the Modify Bearer Request to the S-GW.

206. After receiving the Modify Bearer Request or the Create Bearer Request, the S-GW determines that the UE application trigger request needs to be sent to the M2M device through a corresponding default bearer or dedicated bearer.

It should be understood that the function of sending, by the MME, the Modify Bearer Request or the Create Bearer Request is not necessarily to instruct the S-GW to modify a bearer or create a bearer, and therefore after receiving the Modify Bearer Request or the Create Bearer Request, the S-GW may obtain the UE application trigger request therein, but does not execute a bearer modification or bearer creation operation.

The S-GW sends a Modify Bearer Response or a Create Bearer Response to the MME.

FIG. 2 shows an example where the S-GW sends the Modify Bearer Response to the MME.

207. The S-GW sends a Downlink Data to the M2M device, where the Downlink Data carries the UE application trigger request.

208. The M2M device establishes a communication channel to the Application Server, and the Application Server and the M2M device perform data exchange.

209. After the M2M device and the Application Server initiate communication, the MME may delete the UE application trigger request stored by the MME, and may send a Notify Request to the HSS, where the Notify Request may carry an ACK of UE application trigger request, to indicate that the UE application trigger request is already successfully sent to the M2M device.

210. The HSS sends a Notify Answer to the MME, and may delete the UE application trigger request stored by the HSS.

It can be seen from the above that, in this embodiment, after receiving the UE application trigger request sent by the HSS, the MME delivers the UE application trigger request to the gateway network element through an actively originated control plane request, and the gateway network element delivers the UE application trigger request to the corresponding device through a user plane data packet. The mechanism improves initiative and real-timeness of a network in delivering the UE application trigger request, thereby making a device exchange data with an application server in a more timely and efficient manner.

To make the technical solutions of the embodiment of the present invention be better understood and implemented, the following provides illustration by using an example of another application scenario where an M2M device is triggered in an LTE system. An application scenario of triggering an H2H device may be derived accordingly.

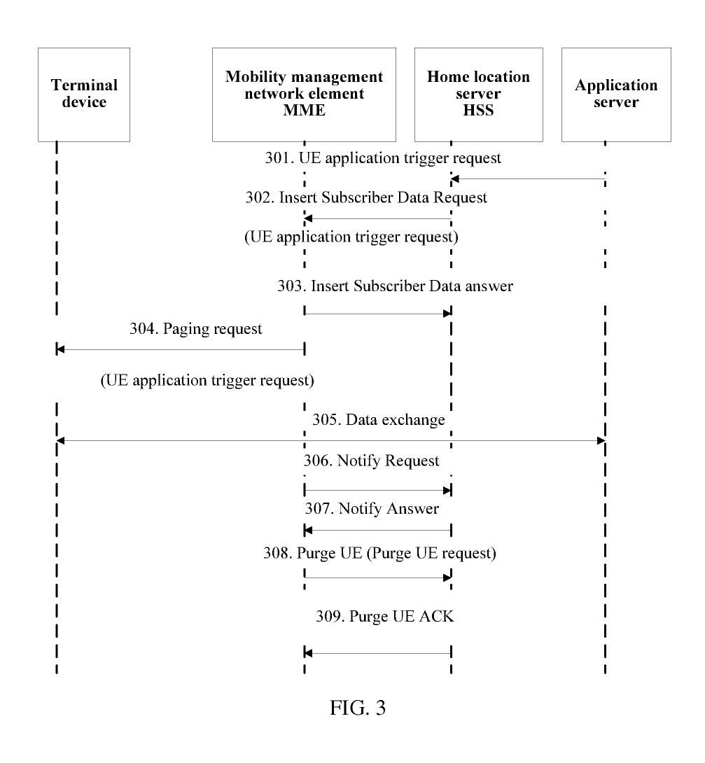

Referring to FIG. 3, specific steps may include:

301. An Application Server sends a UE application trigger request to an HSS.

In an actual application, the Application Server may directly send the UE application trigger request to the HSS, or make the UE application trigger request be carried in a certain message and sent to the HSS. The UE application trigger request may carry a device identifier of an M2M device that needs to be triggered.

In addition, the Application Server may further send a high priority processing instruction to the HSS at the same time when sending the UE application trigger request to the HSS, so as to instruct a device, which receives the UE application trigger request, to process the UE application trigger request in a timely manner.

302. The HSS receives and stores the UE application trigger request.

The HSS sends the UE application trigger request to an MME.

In an actual application, the HSS, for example, may make the UE application trigger request be carried in an Insert Subscriber Data Request, a Cancel Location request, or another message and sent to the MME. FIG. 3 shows an example where the HSS makes the UE application trigger request be carried in the Insert Subscriber Data Request and sent to the MME.

In addition, the HSS may further make a high priority processing instruction be carried in the message that is sent to the MME and carries the UE application trigger request, so as to instruct a device, which receives the UE application trigger request, to process the UE application trigger request in a timely manner.

303. The MME receives the UE application trigger request from the HSS.

The MME, for example, may receive the Insert Subscriber Data Request, the Cancel Location request, or another message, where the Insert Subscriber Data Request, the Cancel Location request, or the another message is from the HSS and carries the UE application trigger request, and obtain the UE application trigger request therein from the HSS.

The MME may send an Insert Subscriber Data answer, a Cancel Location ACK response, or another corresponding response to the HSS, and FIG. 3 shows an example where the MME sends the Insert Subscriber Data answer to the HSS.

304. The MME may determine, according to the high priority processing instruction, that a Paging request needs to be actively sent to the M2M device, and make the UE application trigger request be carried in the Paging request.

The UE application trigger request, for example, may be carried in a non Critical Extension field or another field of the Paging request.

It can be understood that FIG. 3 shows an example where the MME actively delivers the UE application trigger request to the M2M device through the Paging request, and certainly the MME may also actively deliver the UE application trigger request to the M2M device through a Detach request or another control plane request. If the MME may actively deliver the UE application trigger request to the M2M device through a Detach request message, the M2M device needs to return a Detach Reject response to the MME. Herein, the function of sending, by the MME, the Detach request is not to instruct the device to detach, and therefore, after receiving the Detach request, the M2M device may obtain the UE application trigger request therein, but does not execute detaching.

305. The M2M device establishes a communication channel to the Application Server, and the Application Server and the M2M device perform data exchange.

306. After the M2M device and the Application Server initiate communication, the MME may delete the UE application trigger request stored by the MME, and may send a Notify Request to the HSS, where the Notify Request may carry an ACK of UE application trigger request, to indicate that the UE application trigger request is already successfully sent to the M2M device.

307. The HSS sends a Notify Answer to the MME.

308. The MME sends a Purge UE request to the HSS, where the Purge UE request carries an instruction of deleting the UE application trigger request.

309. The HSS deletes the UE application trigger request stored by the HSS, and may send a Purge UE ACK to the MME.

It can be seen from the above that, in this embodiment, after receiving the UE application trigger request, the MME delivers the UE application trigger request to the device through an actively originated control plane request. The mechanism improves initiative and real-timeness of a network in delivering the UE application trigger request, thereby making a device exchange data with an Application Server in a more timely and efficient manner.

To make the technical solutions of the embodiment of the present invention be better understood and implemented, the following provides illustration by using an example of another application scenario where an M2M device is triggered in an LTE system. An application scenario of triggering an H2H device may be derived accordingly.

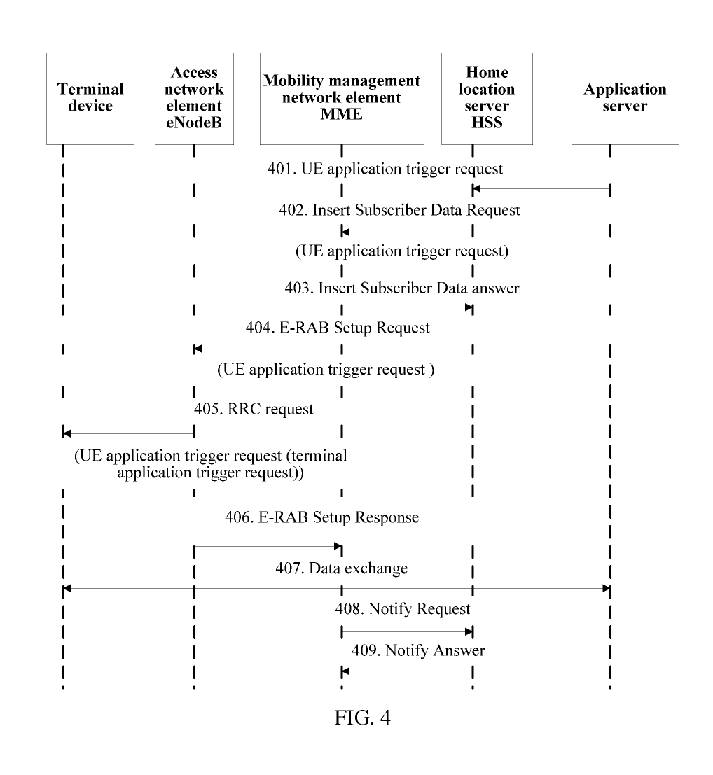

Referring to FIG. 4, specific steps may include:

401. An Application Server sends a UE application trigger request to an HSS.

In an actual application, the Application Server may directly send the UE application trigger request to the HSS, or make the UE application trigger request be carried in a certain message and sent to the HSS. The UE application trigger request may carry a device identifier of an M2M device that needs to be triggered.

In addition, the Application Server may further send a high priority processing instruction to the HSS at the same time when sending the UE application trigger request to the HSS, so as to instruct a device, which receives the UE application trigger request, to process the UE application trigger request in a timely manner.

402. The HSS receives and stores the UE application trigger request.

The HSS sends the UE application trigger request to an MME.

In an actual application, the HSS, for example, may make the UE application trigger request be carried in an Insert Subscriber Data Request, a Cancel Location request, or another message and sent to the MME. FIG. 4 shows an example where the HSS makes the UE application trigger request be carried in the Insert Subscriber Data Request and sent to the MME.

In addition, the HSS may further make a high priority processing instruction be carried in the request or the message, where the request or the message is sent to the MME and carries the UE application trigger request, so as to instruct a device, which receives the UE application trigger request, to process the UE application trigger request in a timely manner.

403. The MME receives the UE application trigger request from the HSS.

The MME, for example, may receive the Insert Subscriber Data Request, the Cancel Location request, or another message, where the Insert Subscriber Data Request, the Cancel Location request, or the another message is from the HSS and carries the UE application trigger request, and obtain the UE application trigger request therein from the HSS.

The MME may send an Insert Subscriber Data answer, a Cancel Location ACK response, or another corresponding response to the HSS, and FIG. 4 shows an example where the MME sends the Insert Subscriber Data answer to the HSS.

404. The MME may determine, according to the UE application trigger request and the high priority processing instruction, that an evolved radio access bearer (E-RAB) Setup Request needs to be sent to an eNodeB, so as to deliver the UE application trigger request to the device at the same time when establishing a radio resource link.

It should be understood that FIG. 4 shows an example where the MME actively delivers the UE application trigger request to the eNodeB through the E-RAB Setup Request, and certainly the MME may also actively deliver the UE application trigger request to the eNodeB through an E-RAB Modify Request, an E-RAB Release Request, or another control plane request.

The UE application trigger request, for example, may be in an EPS-PDU or another field of an E-RAB Setup Request, the E-RAB Modify Request, or the E-RAB Release Request.

405. The eNodeB sends an RRC request to the M2M device, where the RRC request carries the UE application trigger request.

The UE application trigger request, for example, may be in a critical Extensions Future field or another field of the RRC request.

The M2M device receives the RRC request, and establishes an RRC link, and after establishing an RRC, the M2M device may return a corresponding response to the eNodeB.

406. The eNodeB returns an E-RAB Setup Response (S1-AP:E-RAB Setup Response) to the MME.

407. The M2M device and the Application Server establish a communication channel, and the Application Server and the M2M device perform data exchange.

Because the M2M device already establishes the radio resource link with the eNodeB, at this time, only a communication channel of another band needs to be established between the M2M device and the Application Server.

408. After the M2M device and the Application Server perform communication, the MME may delete the UE application trigger request stored by the MME, and may send a Notify Request to the HSS, where the Notify Request may carry an ACK of UE application trigger request, to indicate that the UE application trigger request is already successfully sent to the M2M device.

409. The HSS sends a Notify Answer to the MME, and may delete the UE application trigger request stored by the HSS.

It can be seen from the above that, in this embodiment, after receiving the UE application trigger request sent by the HSS, the MME delivers the UE application trigger request to the access network element through an actively originated control plane request, and the access network element delivers the UE application trigger request to the corresponding device through a user plane data packet. The mechanism improves initiative and real-timeness of a network in delivering the UE application trigger request, thereby making a device exchange data with an application server in a more timely and efficient manner.

To make the technical solutions of the embodiment of the present invention be better understood and implemented, the following provides illustration by using an example of an application scenario where an M2M device fails to be triggered in an LTE system. An application scenario of failed triggering of an H2H device may be derived accordingly.

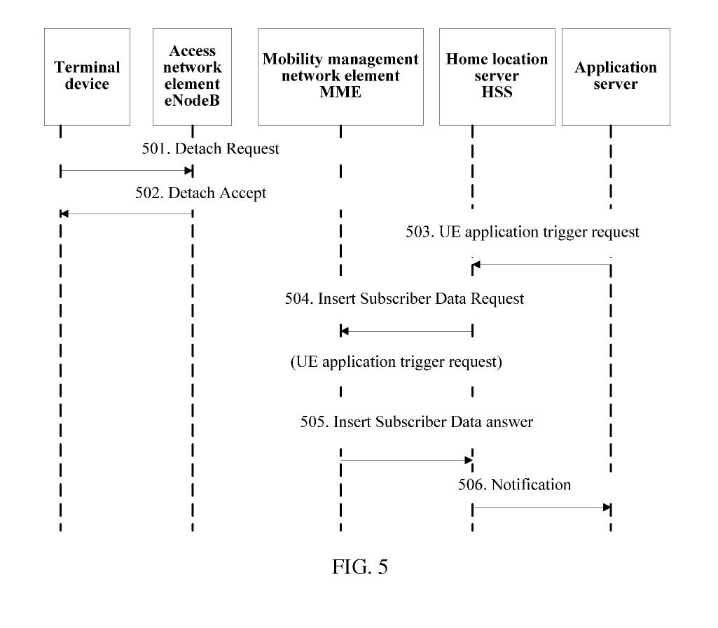

Referring to FIG. 5, specific steps may include:

501-502. An M2M device completes detaching.

503. An Application Server sends a UE application trigger request to an HSS.

In an actual application, the Application Server may directly send the UE application trigger request to the HSS, or make the UE application trigger request be carried in a certain message and sent to the HSS. The UE application trigger request may carry a device identifier of an M2M device that needs to be triggered.

In addition, the Application Server may further send a high priority processing instruction to the HSS at the same time when sending the UE application trigger request to the HSS, so as to instruct a device, which receives the UE application trigger request, to process the UE application trigger request in a timely manner.

504. The HSS receives and stores the UE application trigger request.

The HSS sends the UE application trigger request to an MME.

In an actual application, the HSS, for example, may make the UE application trigger request be carried in an Insert Subscriber Data Request, a Cancel Location request, or another message and sent to the MME. FIG. 5 shows an example where the HSS makes the UE application trigger request be carried in the Insert Subscriber Data Request and sent to the MME.

In addition, the HSS may further make a high priority processing instruction be carried in the message that is sent to the MME and carries the UE application trigger request, so as to instruct a device, which receives the UE application trigger request, to process the UE application trigger request in a timely manner.

505. The MME determines that the M2M device already detaches.

The MME returns an Insert Subscriber Data Answer response to the HSS, where the response carries indication information of a trigger failure, and may further carry a cause of the trigger failure, for example, the M2M device fails and already detaches.

506. The HSS deletes, according to the received Insert Subscriber Data Answer response, the UE application trigger request stored by the HSS.

The HSS sends a Notification request to the Application Server, where the Notification request may carry an indication of a failure in triggering the M2M device, and may further carry a cause of the failure in the triggering, for example, the M2M device fails and already detaches.

It can be seen from the above that, in this embodiment, after the MME receives the UE application trigger request sent by the HSS, if the MME determines that the M2M device already detaches, the MME instructs the HSS to delete the stored UE application trigger request, and the HSS indicates a trigger failure to the Application Server. The mechanism improves initiative and real-timeness of the Application Server in obtaining a trigger result.

To make the technical solutions of the embodiment of the present invention be better understood and implemented, the following provides illustration by using an example of another application scenario where an M2M device fails to be triggered in an LTE system. An application scenario of failed triggering of an H2H device may be derived accordingly.

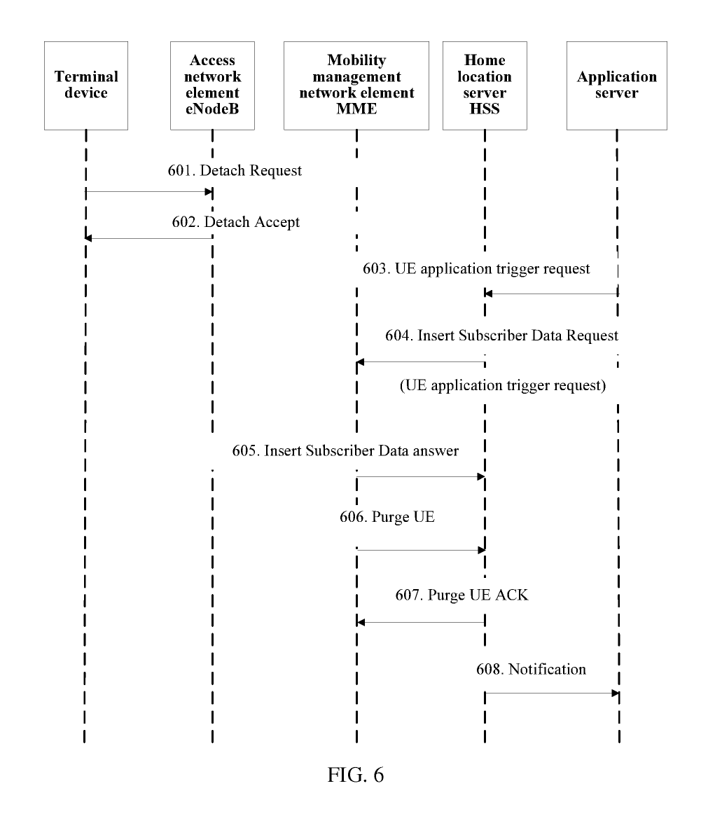

Referring to FIG. 6, specific steps may include:

601-602. An M2M device completes detaching.

603. An Application Server sends a UE application trigger request to an HSS.

In an actual application, the Application Server may directly send the UE application trigger request to the HSS, or make the UE application trigger request be carried in a certain message and sent to the HSS. The UE application trigger request may carry a device identifier of an M2M device that needs to be triggered.

In addition, the Application Server may further send a high priority processing instruction to the HSS at the same time when sending the UE application trigger request to the HSS, so as to instruct a device, which receives the UE application trigger request, to process the UE application trigger request in a timely manner.

604. The HSS receives and stores the UE application trigger request.

The HSS sends the UE application trigger request to an MME.

In an actual application, the HSS, for example, may make the UE application trigger request be carried in an Insert Subscriber Data Request, a Cancel Location request, or another request or message and sent to the MME. FIG. 6 shows an example where the HSS makes the UE application trigger request be carried in the Insert Subscriber Data Request and sent to the MME.

In addition, the HSS may further make a high priority processing instruction be carried in the message that is sent to the MME and carries the UE application trigger request, so as to instruct a device, which receives the UE application trigger request, to process the UE application trigger request in a timely manner.

605. The MME determines that the M2M device already detaches.

The MME returns an Insert Subscriber Data Answer response to the HSS, where the response carries indication information of a trigger failure, and may further carry a cause of the trigger failure, for example, the M2M device fails and already detaches.

606. The MME sends a Purge UE request to the HSS, where the Purge UE request carries an instruction of deleting the UE application trigger request.

607. The HSS deletes the UE application trigger request stored by the HSS, and may send a Purge UE ACK to the MME.

608. The HSS sends a Notification request to the Application Server, where the Notification request may carry an indication of a failure in triggering the M2M device, and may further carry a cause of the failure in the triggering, for example, the M2M device fails and already detaches.

It can be seen from the above that, in this embodiment, after the MME receives the UE application trigger request sent by the HSS, if the MME determines that the M2M device already detaches, the MME instructs the HSS to delete the stored UE application trigger request, and the HSS indicates a trigger failure to the Application Server. The mechanism improves initiative and real-timeness of the Application Server in obtaining a trigger result.

It should be noted that, for the methods according to the embodiments, for purposes of simplicity of explanation, the methods are described as a combination of a series of actions, but it should be clear to persons skilled in the art that the present invention is not limited by the order of the actions, because certain steps can, according to the present invention, be performed in another order or concurrently. In addition, persons skilled in the art should also know that the embodiments described in the specification all fall within exemplary embodiments, and the related actions and modules are not necessarily required by the present invention.

To make the technical solutions of the embodiment of the present invention better implemented, the following provides a related device for implementing the method according to the embodiment.

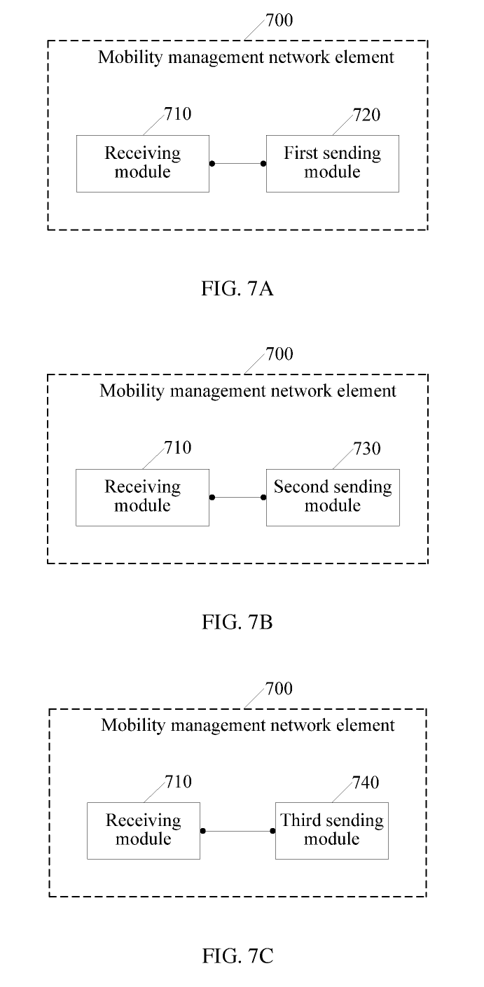

Referring to FIG. 7A, FIG. 7B, and FIG. 7C, a mobility management network element 700 according to an embodiment of the present invention may include: a receiving module 710 and a first sending module 720, or include the receiving module 710 and a second sending module 730, or include the receiving module 710 and a third sending module 740.

The receiving module 710 is configured to receive a device application trigger request.

The first sending module 720 is configured to send a request carrying the device application trigger request to an access network element to make the access network element trigger a device (for example, an H2H device or an M2M device).

The second sending module 730 is configured to send a request carrying the device application trigger request to a gateway network element to make the gateway network element trigger a device (for example, an H2H device or an M2M device).

The third sending module 740 is configured to send a request carrying the device application trigger request to a device to trigger the device (for example, an H2H device or an M2M device).

In an application scenario, the third sending module 740 is specifically configured to send a Paging request carrying the device application trigger request to the device to trigger the device; or send a Detach request carrying the device application trigger request to the device to trigger the device.

For example, the third sending module 740 may make the UE application trigger request be carried in a non Critical Extension field or another field of the Paging request, the device may correspondingly obtain the UE application trigger request from the non Critical Extension field or the another field of the Paging request, and the device may perform data exchange with an Application Server accordingly.

In an application scenario, the first sending module 720 is specifically configured to send a radio access bearer setup request carrying the device application trigger request to an access network element to make the access network element trigger the device; or, send a radio access bearer modification request carrying the device application trigger request to an access network element to make the access network element trigger the device; or, send a radio access bearer release request carrying the device application trigger request to an access network element to make the access network element trigger the device.

For example, the first sending module 720 may make the received UE application trigger request be carried in an EPS-PDU or another field of a radio access bearer setup request, a radio access bearer modification request, or a radio access bearer release request, and after receiving the radio access bearer setup request, the radio access bearer modification request, or the radio access bearer release request, the access network element may obtain the UE application trigger request from the EPS-PDU or the another field of the message.

In an application scenario, the second sending module 730 is specifically configured to send a Modify Bearer Request carrying the device application trigger request to a gateway network element to make the gateway network element trigger the device; or, send a Create Bearer Request carrying the device application trigger request to the gateway network element to make the gateway network element trigger the device.

For example, the second sending module 730 may make the UE application trigger request be carried in a Protocol Configuration Option field or another field of the Modify Bearer Request or the Create Bearer Request, and after receiving the Modify Bearer Request or the Create Bearer Request, the gateway network element may obtain the UE application trigger request from the Protocol Configuration Option field or the another field of the request message.

It should be understood that the mobility management network element 700 of this embodiment may be as the mobility management network element (for example, an MME) in the foregoing method embodiment, functions of functional modules thereof may be specifically implemented according to the method in the method embodiment, and for a specific implementation process thereof, reference may be made to the related description in the foregoing method embodiment, which is not repeated herein.

It can be seen from the above that, in this embodiment, after receiving the device application trigger request, the mobility management network element 700 delivers the device application trigger request to the device through an actively originated control plane request to trigger the device or delivers the device application trigger request to an access network element or a gateway network element through an actively originated control plane request, so as to enable the access network element or the gateway network element to deliver the device application trigger request to the corresponding device to trigger the device. The mechanism improves initiative and real-timeness of a network in delivering the device application trigger request, thereby triggering a device, such as an M2M device or an H2H device, in a more timely and efficient manner to exchange data with an application server.

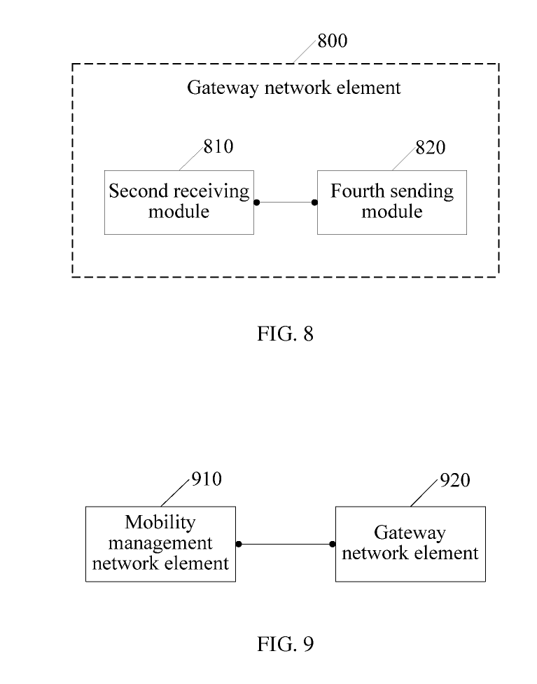

Referring to FIG. 8, a gateway network element 800 according to an embodiment of the present invention may include: a second receiving module 810 and a fourth sending module 820.

The second receiving module 810 is configured to receive a request that is from a mobility management network element and carries a device application trigger request.

The fourth sending module 820 is configured to send a data packet (for example, a downlink data packet) carrying the device application trigger request to a device to trigger the device.

It should be understood that the gateway network element 800 of this embodiment may be as the gateway network element (for example, an eNodeB) in the foregoing method embodiment, functions of functional modules thereof may be specifically implemented according to the method in the method embodiment, and for a specific implementation process thereof, reference may be made to the related description in the foregoing method embodiment, which is not repeated herein.

It can be seen from the above that, in this embodiment, after receiving the device application trigger request, the mobility management network element delivers the device application trigger request to the gateway network element 800 through an actively originated control plane request, and the gateway network element 800 delivers the device application trigger request to the corresponding device to trigger the device. The mechanism improves initiative and real-timeness of a network in delivering the device application trigger request, thereby triggering a device, such as an M2M device or an H2H device, in a more timely and efficient manner to exchange data with an application server.

An embodiment of the present invention further provides a communication system, which includes:

a mobility management network element 700 or a gateway network element 800.

Referring to FIG. 9, another communication system according to an embodiment of the present invention includes: a mobility management network element 910 and a gateway network element 920.

The mobility management network element 910 is configured to receive a device application trigger request; and send a request carrying the device application trigger request to the gateway network element 920.

The gateway network element 920 is configured to receive the request that is from the mobility management network element 910 and carries the device application trigger request; and send a data packet carrying the device application trigger request to a device to trigger the device.

It should be understood that in this embodiment, the mobility management network element 910 may be as the mobility management network element 700, the gateway network element 920 may be as the gateway network element 800, functions of the mobility management network element 910 and the gateway network element 920 may be specifically implemented according to the method in the method embodiment, and for a specific implementation process thereof, reference may be made to the related description in the foregoing method embodiment, which is not repeated herein.

In the foregoing embodiments, description for each embodiment has its own emphasis, and a part without being described in detail in a certain embodiment can be obtained with reference to relevant description in other embodiments.

In conclusion, in the embodiment of the present invention, after receiving the device application trigger request, the mobility management network element delivers the device application trigger request to the device through an actively originated control plane request to trigger the device or delivers the device application trigger request to an access network element or a gateway network element through an actively originated control plane request, so as to enable the access network element or the gateway network element to deliver the device application trigger request to the corresponding device to trigger the device. The mechanism relatively improves initiative and real-timeness of a network in delivering the device application trigger request, thereby triggering a device, such as an M2M device or an H2H device, in a more timely and efficient manner to exchange data with an application server.

Persons of ordinary skill in the art may understand that all or a part of the steps of the methods in the embodiments may be implemented by a program instructing relevant hardware. The program may be stored in a computer readable storage medium. The storage medium may include a read-only memory, a random access memory, a magnetic disk, an optical disk, or the like.

The device triggering method and the network element device according to the embodiments of the present invention are described above in detail. The principle and implementation manner of the present invention are described herein through specific examples. The description about the embodiments is merely used for ease of understanding of the methods and core ideas of the present invention. In addition, persons of ordinary skill in the art may make modifications to specific implementation manners and application scopes according to the ideas of the present invention. In conclusion, the content of this specification shall not be construed as a limitation on the present invention.

What is claimed is:

1. A device triggering method, comprising:
receiving, by a mobility management network element, a device application trigger request, wherein the device application trigger request comprises a device identifier;
determining, by the mobility management network element, whether a device corresponding to the device identifier already detaches;
sending, by the mobility management network element, a request carrying the device application trigger request to an access network element to make the access network element trigger a device when the device corresponding to the device identifier is not already detached; and
sending, by the mobility management network element, a message indicating a failure in the triggering the device to a home location server when the device corresponding to the device identifier is already detached.

2. The method according to claim 1, wherein sending, by the mobility management network element, the request carrying the device application trigger request to the access network element to make the access network element trigger the device comprises sending, by the mobility management network element, a radio access bearer setup request carrying the device application trigger request to the access network element to make the access network element trigger the device.

3. The method according to claim 1, wherein sending, by the mobility management network element, the request carrying the device application trigger request to the access network element to make the access network element trigger the device comprises sending, by the mobility management network element, a radio access bearer modification request carrying the device application trigger request to the access network element to make the access network element trigger the device.

4. The method according to claim 1, wherein sending, by the mobility management network element, the request carrying the device application trigger request to the access network element to make the access network element trigger the device comprises sending, by the mobility management network element, a radio access bearer release request carrying the device application trigger request to the access network element to make the access network element trigger the device.

5. The method according to claim 2, wherein the device application trigger request is carried in an evolved packet system-protocol data unit (EPS-PDU) of the radio access bearer setup request.

6. The method according to claim 3, wherein the device application trigger request is carried in an evolved packet system-protocol data unit (EPS-PDU) of the radio access bearer modification request.

7. The method according to claim 4, wherein the device application trigger request is carried in an evolved packet system-protocol data unit (EPS-PDU) of the radio access bearer release request.

8. A mobility management network element, configured to:
receive a device application trigger request, wherein the device application trigger request comprises a device identifier;
determine whether a device corresponding to the device identifier already detaches;
send a request carrying the device application trigger request to an access network element to make the access network element trigger a device when the device corresponding to the device is not already detached; and
send a message indicating a failure in the triggering the device to a home location server when the device corresponding to the device is already detached.

9. The mobility management network element according to claim 8, wherein the mobility management network element is configured to send the request carrying the device application trigger request to the access network element to make the access network element trigger the device comprises the mobility management network element being further configured to send a radio access bearer setup request carrying the device application trigger request to the access network element to make the access network element trigger the device.

10. The mobility management network element according to claim 8, wherein the mobility management network element is configured to send the request carrying the device application trigger request to the access network element to make the access network element trigger the device comprises the mobility management network element being further configured to send a radio access bearer modification request carrying the device application trigger request to the access network element to make the access network element trigger the device.

11. The mobility management network element according to claim 8, wherein the mobility management network element is configured to send the request carrying the device application trigger request to the access network element to make the access network element trigger the device comprises the mobility management network element being further configured to send a radio access bearer release request carrying the device application trigger request to the access network element to make the access network element trigger the device.

12. The mobility management network element according to claim 9, wherein the device application trigger request is carried in an evolved packet system-protocol data unit (EPS-PDU) of the radio access bearer setup request.

13. The mobility management network element according to claim 10, wherein the device application trigger request is carried in an evolved packet system-protocol data unit (EPS-PDU) of the radio access bearer modification request.

14. The mobility management network element according to claim 11, wherein the device application trigger request is carried in an evolved packet system-protocol data unit (EPS-PDU) of the radio access bearer release request.

15. A non-transitory computer-readable medium having computer usable instructions stored thereon for execution by a processor, wherein the instructions cause the processor to:
receive a device application trigger request, wherein the device application trigger request comprises a device identifier;
determine whether a device corresponding to the device identifier already detaches;
send a request carrying the device application trigger request to an access network element to make the access network element trigger a device when the device corresponding to the device is not already detached; and
send a message indicating a failure in the triggering the device to a home location server when the device corresponding to the device is already detached.

16. The non-transitory computer-readable medium of claim 15, wherein the instructions cause the processor to send the request carrying the device application trigger request to the access network element to make the access network element trigger the device comprises the instructions further causing the processor to send a radio access bearer setup request carrying the device application trigger request to the access network element to make the access network element trigger the device.

17. The non-transitory computer-readable medium of claim 15, wherein the instructions cause the processor to send the request carrying the device application trigger request to the access network element to make the access network element trigger the device comprises the instructions further causing the processor to send a radio access bearer modification request carrying the device application trigger request to the access network element to make the access network element trigger the device.

18. The non-transitory computer-readable medium of claim 15, wherein the instructions cause the processor to send the request carrying the device application trigger request to the access network element to make the access network element trigger the device comprises the instructions further causing the processor to send a radio access bearer release request carrying the device application trigger request to the access network element to make the access network element trigger the device.

19. The non-transitory computer-readable medium of claim 16, wherein the device application trigger request is carried in an evolved packet system-protocol data unit (EPS-PDU) of the radio access bearer setup request.

20. The non-transitory computer-readable medium of claim 17, wherein the device application trigger request is carried in an evolved packet system-protocol data unit (EPS-PDU) of the radio access bearer modification request.
